(19) United States
(12) Patent Application Publication
(10) Pub. No.: US 2015/0197945 A1
(43) Pub. Date: Jul. 16, 2015

(54) Decking gauge

(71) Applicant: John Hamilton, Brisbane (AU)

(72) Inventor: John Hamilton, Brisbane (AU)

(21) Appl. No.: 14/040,762

(22) Filed: Jan. 14, 2014

(51) Int. Cl. E04F 21/00; G01B 3/30

(52) U.S. Cl. CPC E04F 21/0092; G01B 3/30

(57) ABSTRACT

The decking gauge allows the decking installer to achieve the same even gaps between decking planks/boards up to 6 decking boards at a time, cutting the time it takes to achieve the gaps between the boards by more than half the time.

My abstraction of the V shaped teeth on this gauge had been designed to set the gap halfway down each tooth, enabling the gauge to smoothly slot in between each plank/board and will set the same even gap.

The decking gauges can position up to 6 decking boards/planks prior to nailing/screwing the decking boards to the joists. This allows the installer to achieve a faster installation of the decking boards.

### FEATURES DEFINING THIS INVENTION ARE AS FOLLOWS

### 1] THE DECKING GAUGE IS A HAND HELD TOOL WHICH ALLOWS THE USER TO POSITION DECKING BOARDS PRIOR TO SCREWING OR NAILING.

### 2] THE TOOL SETS OUT PERFECT GAPS BETWEEN THE DECKING BOARDS/PLANKS.

### 3] THE REQUIRED GAP FOR ANY SIZE DECKING BOARDS/PLANKS IS SET HALFWAY ON EACH OF THE ANGLED TEETH, THUS MAKING THE GAUGES SELF SETTING WITH PERFECT GAPS ACHIEVED BETWEEN BOARDS/PLANKS.

### 4] THE MATERIALS USED IN THE MANUFACTURE OF THE DECKING GAUGE CAN BE STEEL/ALUMINIUM/PLASTICS/NYLON'S OR A COMBINATION OF ANY OF THE MENTIONED MATERIALS.

### 5] THE SHAPE OF THE GAUGE IS DESIGNED TO ACCOMMODATE OTHER FEATURES.

### BRIEF DESCRIPTION OF THE SUBSTITUTE DRAWINGS/FIGURES. 1 . . . 2 . . . and 3

FIG. 1.

Shows the decking gauge tool from above outlining the round handle shape and the thickness of the decking gauge tool.

FIG. 2.

Shows the decking gauge tool from the side outlining the round handle shape and the thickness of the decking gauge tool.

FIG. 3.

Shows the decking gauge tool from the front, showing the shape of the handle and the shape of the decking gauge tool.

It also shows the unique shape of the teeth on the decking gauge tool which are designed to give perfect gaps between decking boards, as the exact gap required for any width decking board is set halfway on each tooth directly parallel to each other.

### SPECIFICATION DRAWINGS DESCRIPTIONS AS FOLLOWS

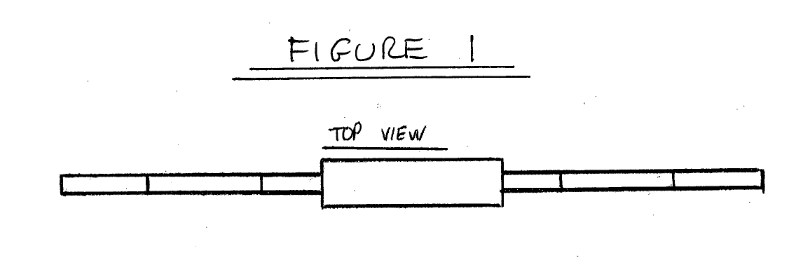

FIG. 1

This is the top view of the decking gauge tool, showing the handle and the width of the tool from above.

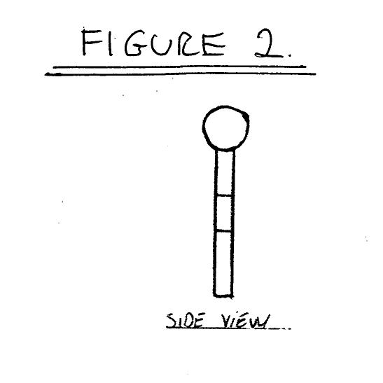

FIG. 2

This is the side view of the decking gauge tool, showing the handle of the tool and the width of the decking gauge tool from a side view.

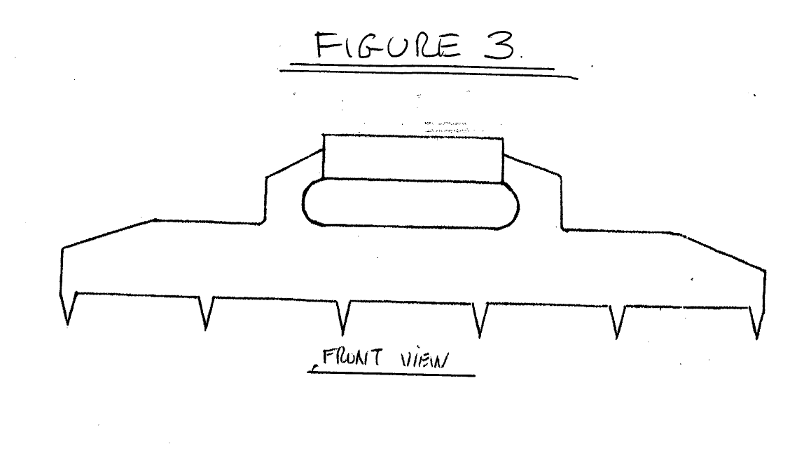

FIG. 3

This is the front view of the tool, showing the handle, and the angled teeth on the decking gauge tool and the shape of the decking gauge tool.

### 6] FIG. 1 SHOWS THE TOP VIEW OF THE TOOL

FIG. 2 SHOWS THE SIDE VIEW OF THE TOOL
FIG. 3 SHOWS THE FRONT VIEW OF THE TOOL

1. My claim is that I have invented a decking gauge tool for the Decking Industry that has a V shaped tooth which effortlessly slots between specific sized decking boards. The gauge will position up to 6 boards at a time prior to nailing/screwing the boards to the joists. This enables the installer to lay the mutable boards faster and with perfect gaps every time. The required gap is set halfway down each tooth which allows the teeth to self set between the boards, thus achieving the perfect gaps between each decking board. The decking gauge tool can be made from Plastic, aluminium, steel, composite material, high density polyethylene or polypropylene, hard rubber.
